(19) United States
(12) Patent Application Publication
(10) Pub. No.: US 2012/0128057 A1
(43) Pub. Date: May 24, 2012

(54) NETWORK NODE, IN PARTICULAR, FOR A SENSOR NETWORK, AND OPERATIONAL METHOD FOR A NETWORK NODE

(76) Inventors: Dirk Daecke, Stuttgart (DE); Bernhard Opitz, Leonberg (DE); Stefan Doehren, Remshalden-Grunbach (DE)

(21) Appl. No.: 13/294,716

(22) Filed: Nov. 11, 2011

(30) Foreign Application Priority Data
Nov. 22, 2010 (DE) 10 2010 044 208.9

(51) Int. Cl. H04L 27/00

(52) U.S. Cl. 375/239

(57) ABSTRACT

A network node, in particular, for a sensor network, is configured to receive sensor data from at least one further network node transmitting the sensor data. The network node has a time stamp device, which is configured to assign received sensor data values time stamps, which represent a time of reception of the sensor data values at the network node with respect to a primary time reference assigned to the network node.

### RELATED APPLICATION INFORMATION

The present application claims priority to and the benefit of German patent application no. 10 2010 044 208.9, which was filed in Germany on Nov. 22, 2010, the disclosure of which is incorporated herein by reference.

### FIELD OF THE INVENTION

The present invention relates to a′ network node, in particular, for a sensor network, the network node being configured to receive sensor data from at least one further network node transmitting the sensor data. The present invention further relates to an operational method for such a network node. In addition, the present invention relates to a network node, in particular, for a sensor network, the network node being configured to acquire at least one sensor signal and to transmit sensor data characterizing the acquired sensor signal to at least one network node receiving the sensor data. The present invention further relates to an operational method for such a network node.

### BACKGROUND INFORMATION

A network node of the type mentioned above is discussed in US 2007/0219751A1. The network node is configured to provide an acquired sensor signal with time stamps and to transmit the sensor signal, together with the time stamps, to another device. This demands a large amount of structural expenditure, because the time stamps must be applied to the sensor signal locally, that is, in a sensor network node. The provision of a highly precise time reference in the sensor network node is necessary for this. Furthermore, the sending of the acquired sensor signal, as well as associated time stamps, has the significant disadvantage that a payload data bandwidth of the transmission medium is reduced by sending the time stamps along, which means that fewer sensor data per unit time may be transmitted to a receiving network node.

### SUMMARY OF THE INVENTION

Accordingly, an object of the exemplary embodiments and/or exemplary methods of the present invention is to improve a network node and an operational method for a network node of the type mentioned at the outset, such that the above-mentioned disadvantages of the related art are eliminated.

This object is achieved in a network node of the type mentioned at the outset, in that the network node has a time-stamp device, which is configured to assign received sensor data values time stamps that represent a time of reception of the sensor data values at the network node with respect to a primary time reference assigned to the network node.

In this manner, one may advantageously dispense with a network node transmitting the sensor data having to perform time stamping itself, as well as with the sensor data having to be transmitted, together with the time stamps, to a receiving network node. In an advantageous manner, the network nodes of the exemplary embodiments and/or exemplary methods of the present invention that receive the sensor data may themselves undertake time stamping, which defines the entry time of the received sensor data with respect to the primary time reference of the receiving network node, so that subsequent processing of the received sensor data may be carried out independently of any delay times in the receiving network nodes.

A further advantage of the exemplary embodiments and/or exemplary methods of the present invention is that the complete transmission bandwidth of a communication interface, which is normally digitally formed and is between a transmitting network node acquiring the sensor signals and the receiving network node of the exemplary embodiments and/or exemplary methods of the present invention, may be used for transmitting sensor data and does not have to be used for transmitting time stamps.

In an advantageous specific embodiment, it is provided that the network node be configured to ascertain parameters of a secondary time reference of the network nodes sending the sensor data, as a function of a frame length and/or a symbol transmission rate of the received sensor data. Analyses of the applicant have revealed that in the case of a digital data transmission between the transmitting network node and the receiving network node of the exemplary embodiments and/or exemplary methods of the present invention, it is advantageously possible to ascertain information about the time base or time reference of the transmitting network node by evaluating an arrival time of the frame of the digital transmission and/or a frame length and/or a symbol transmission rate of the digitally transmitted signal. This means that although the exemplary embodiments and/or exemplary methods of the present invention may not provide any transmission of time stamp information from a transmitting sensor network node to the receiving network node, the receiving network node may advantageously obtain such information or at least parameters that characterize a secondary time reference of the transmitting network node, from the received signal.

In a further advantageous, specific embodiment, it is provided that the network node be configured to establish a relationship between the primary time reference and secondary time reference as a function of the ascertained parameters of the secondary time reference. With knowledge of such a temporal relationship, the signal acquired at the transmitting (sensor) network node, or corresponding sampling values, may be clearly deduced in an advantageous manner from the sensor data presently in the receiving network node that are provided with a time stamp.

In a particularly advantageous manner, the network node is configured to at least sectionally and/or partially reconstruct a sensor signal originally acquired by the transmitting network node, from the received sensor data values, using the time stamps and/or the relationship between the primary time reference and the secondary time reference. The sectional reconstruction may refer to predefined, interesting time intervals of the sensor signal, for example. In addition, a partial reconstruction may also include further signal processing, such that, e.g., only certain frequency components of the sensor signal are reconstructed as a function of the received sensor data.

In a further advantageous, specific embodiment, the network node is configured to transmit a trigger signal to at least one further network node, in particular, to the network node sending the sensor data; in the at least one further network node, the trigger signal triggering the acquisition of a sensor signal and/or the transmission of sensor data to the network node. In this manner, in spite of the essentially asynchronous operation of the transmitting network node with respect to the receiving network node, it is possible to control, to a certain extent, the acquisition of the sensor signal or the transmitting of sensor data, starting out from the receiving network node.

In a further advantageous, specific embodiment, it is provided that the network node be configured to periodically transmit a trigger signal to at least one further network node, in order to synchronize a secondary time reference of the further network node with the primary time reference.

A network node according to the description herein is specified as a further way to achieve the object of the exemplary embodiments and/or exemplary methods of the present invention. The network node of the exemplary embodiments and/or exemplary methods of the present invention is configured to acquire at least one sensor signal and to transmit sensor data characterizing the acquired sensor signal to at least one network node receiving the sensor data. In addition, the network node of the exemplary embodiments and/or exemplary methods of the present invention is characterized in that it is configured to transmit the sensor data to the receiving network node as a function of a secondary time reference, which is assigned to the network node and is, in particular, asynchronous with respect to a primary time reference of the receiving network node. This allows a design of the transmitting network node (sensor network node) having a particularly low degree of complexity, since the time stamping or a permanent synchronization of the transmitting network node with the network node receiving the sensor data may be dispensed with.

In an advantageous further refinement, the network node is configured to receive a trigger signal and to acquire the sensor signal and/or transmit sensor data to the network node as a function of the trigger signal.

The network node may further receive the trigger signal and, as a function of the trigger signal, synchronize its own, secondary time reference with a primary time reference of a network node sending the trigger signal.

In a further advantageous, specific embodiment, it is provided that the network node be configured to calculate an average value over a plurality of sampling values of the acquired sensor signal, and to transmit the average value to the receiving network node. This specific embodiment is then particularly advantageous, if there is a relatively high sampling rate in the network node evaluating the sensor signal, and if data frames are to be sent to a receiving network node at only a relatively low frequency or transmission rate.

In a further advantageous, specific embodiment, the network node is further configured to perform data compression over a plurality of sampling values of the acquired sensor signal, and to transmit compressed sensor data to the receiving network node.

A method for operating a network node according to the description herein is specified as one more further ways to achieve the object of the exemplary embodiments and/or exemplary methods of the present invention. According to the exemplary embodiments and/or exemplary methods of the present invention, the network node assigns time stamps to received sensor data values, using a time stamp device, the time stamps representing a time of reception of the sensor data values at the network node with respect to a primary time reference assigned to the network node.

Further advantageous refinements are the subject matter of the further descriptions herein.

Additional features, uses and advantages of the exemplary embodiments and/or exemplary methods of the present invention are derived from the following description of exemplary embodiments of the present invention, which are illustrated in the figures of the drawing. In this context, all of the described or illustrated features form the subject matter of the present invention, either alone or in any combination, irrespective of their combination in the patent claims or their antecedent references, and also irrespective of their wording and illustration in the description and in the drawings, respectively.

### BRIEF DESCRIPTION OF THE DRAWINGS

FIG. 1 shows schematically, a sensor network having a receiving network node according to a first specific embodiment, and having a transmitting network node according to a further specific embodiment of the present invention.

FIG. 2 shows a further specific embodiment of the sensor network according to the present invention.

FIGS. 3a, 3b, 3c, 3d, and 3e show a time characteristic of different operating variables of the sensor network according to the present invention.

FIG. 4 show a simplified flow chart of a specific embodiment of the operational method according to the present invention.

FIG. 5 show a simplified flow chart of a further specific embodiment of the operational method according to the present invention.

### DETAILED DESCRIPTION

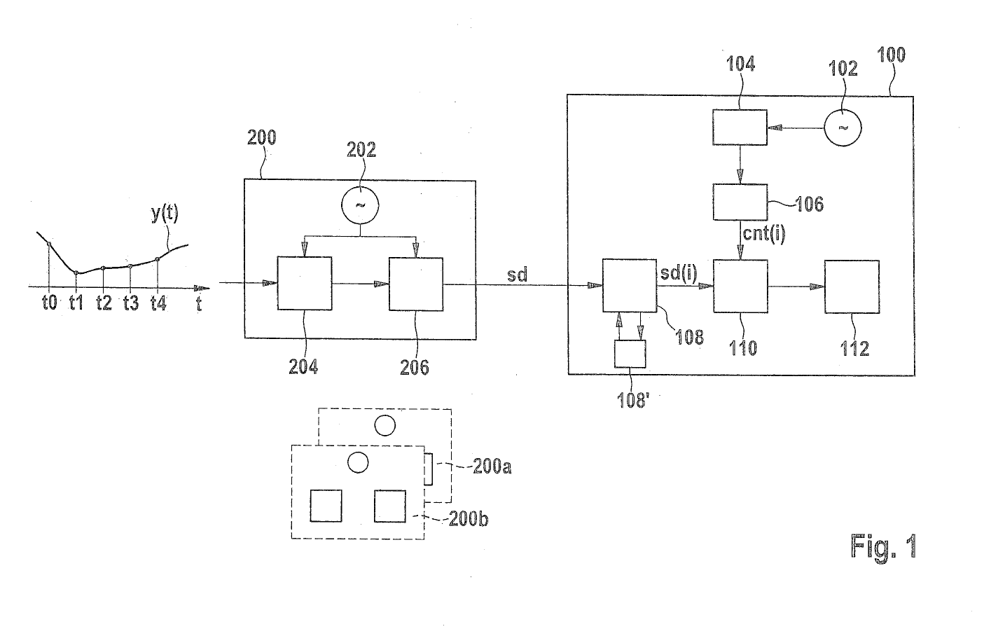

FIG. 1 shows a network node 100, which is configured to receive sensor data sd from at least one further network node 200 transmitting sensor data sd.

Although the specific communication of network nodes 100, 200 is not necessarily limited to one communication direction (send/receive), for the following description, network node 100 is also referred to, inter alia, as a receiving network node, since it receives sensor data sd from further network node 200. Accordingly, the network node 200 transmitting sensor data sd is also referred to below, inter alia, as a transmitting network node.

Network nodes 100, 200 form a sensor network, as is provided, for example, in the area of motor vehicles for acquiring sensor data and for transmitting acquired sensor data sd to a receiving network node 100. Accordingly, in addition to transmitting network node 200, further transmitting network nodes 200a, 200b may also be provided in the sensor network, the functionality of the further transmitting network nodes essentially corresponding to that of transmitting network node 200 and not being described in further detail above.

Transmitting network node 200 is used for acquiring at least one sensor signal y(t), which may be, for example, a time-continuous or value-continuous signal, such as a voltage signal of a pressure sensor or the like. Transmitting network node 200 has a secondary time reference 202, which is integrated into transmitting network node 200, as is apparent from FIG. 1, which means that transmitting network node 200 may use it for controlling its operation. In particular, time reference 202 of transmitting network node 200 is independent of a primary time reference 102 of receiving network node 100 and is normally asynchronous with respect to it.

Transmitting network node 200 acquires sensor signal y(t), for example, using an analog-to-digital (AD) converter, which is not shown in FIG. 1 and samples sensor signal y(t) in a manner known per se. The A/D converter may also be integrated into signal processing unit 204 of transmitting network node 200, for example. Digital sensor data, which are obtained from sensor signal y(t) by signal processing unit 204, are transmitted to digital data transmission unit 206 of transmitting network node 200, the digital data transmission unit transmitting these to receiving network node 100 in the form of sensor data sd. The digital transmission takes place as a function of secondary time reference 202, in the same manner as the processing by signal processing unit 204.

Receiving network node 100 has a digital data transmission unit 108, which may receive sensor data sd and determines individual sensor data values sd(i) from sensor data sd in a manner known per se, e.g., by analyzing individual data frames of the digital communication from transmitting network node 200.

Next to its primary time reference 102, receiving network node 100 has a counter 104 that supplies a counter value under the control of primary time reference 102. The counter value is supplied to a time stamp device 106, which, according to a particular variant of the exemplary embodiments and/or exemplary methods of the present invention, generates a time stamp cnt(i) from the counter value and supplies time stamp cnt(i) to data processing device 110. Received sensor data values sd(i) and corresponding time stamps cnt(i) are combined with each other in data processing device 110, which may contain a memory, as well; each received sensor data value sd(i) being assigned a corresponding time stamp value cnt(i). In this connection, a time stamp value cnt(i) represents the time of reception, at network node 100, of a particular sensor data value sd(i) assigned to the time stamp value, with respect to the primary time reference 102 assigned to network node 100.

This means that the time of reception of a sensor data value sd(i) in receiving network node 100 may be deduced from time stamp cnt(i) of sensor data value sd(i).

Therefore, a subsequent evaluation of received sensor data sd or of individual sensor data values sd(i) by evaluation unit 112 may be temporally triggered, thus, in particular, independently of a transmission rate at which sensor data sd are received at receiving network node 100.

In an advantageous specific embodiment, receiving network node 100 is configured to ascertain parameters of secondary time reference 202 of the transmitting network node 200 sending sensor data sd, as a function of a frame length and/or a symbol transmission rate of received sensor data sd and/or as a function of characteristic pulse shapes or pulse patterns and/or as a function of characteristic patterns of the data stream that contains sensor data sd. In a particular manner, the nominal periods of time of these characteristics of transmitted data sd and signals of transmitting network node 200 are known to receiving network node 100, which means that it may relate the data and measured values y(t) determined by transmitting time reference 202 to its primary time reference 102. In this case, receiving network node 100 may therefore advantageously deduce the characteristics or a clock frequency of secondary time reference 202 of transmitting network node 100, which means that, inter alia, synchronization or at least the generation of a time relationship between primary time reference 102 of receiving network node 100 and secondary time reference 202 of transmitting network node 200 is rendered possible.

The determination of the parameters of secondary time reference 202 is carried out by a timing recovery unit 108 of receiving network node 100, the timing recovery unit having a data connection to digital transmission interface 108.

In a further advantageous, specific embodiment, receiving network node 100 is configured to establish a relationship between primary time reference 102 and secondary time reference 202 as a function of the determined parameters of secondary time reference 202. This relationship between the two time references 102, 202 may be advantageously stored in memory 110 in a manner analogous to time stamp cnt(i), so that it is available for a later evaluation by block 112.

In a further advantageous, specific embodiment, it is provided that receiving network node 100 be configured to at least sectionally and/or partially reconstruct a sensor signal y(t) originally acquired by transmitting network node 200, from received sensor data values sd(i), using time stamps cnt(i) and/or the relationship between primary time reference 102 and secondary time reference 202.

For example, using such an evaluation, receiving network node 100 may reconstruct all of the sampling values at time t0, t1, t2, t3, t4 of sensor signal y(t), as they were also obtained by transmitting network node 200.

Alternatively, receiving network node 100 may also only reconstruct selected sampling values, e.g., every second sampling value at time t0, t2, t4. It is also possible for receiving network node 100 to interpolate sensor signal y(t), e.g., using splines.

Using resampling methods known per se, a series of sensor data values may also be converted from a first sampling frequency, as is defined by transmitting network node 200, to a second sampling frequency, as is provided, e.g., to a further digital signal processing in the scope of evaluation unit 112 or a further device (not shown).

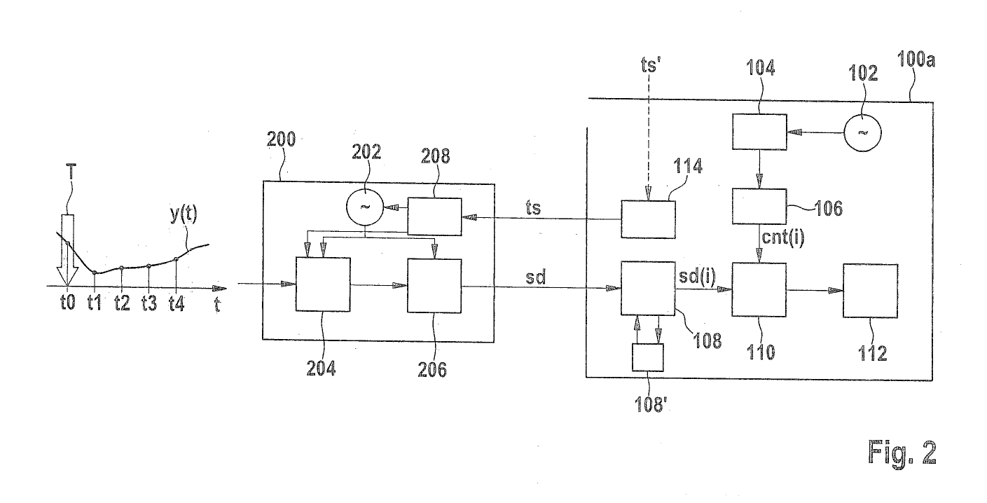

FIG. 2 shows a sensor network according to a further specific embodiment of the present invention. A network node 100a comparable to network node 100 of FIG. 1 additionally has a trigger device 114, with the aid of which receiving network node 100a may transmit a trigger signal ts to transmitting network node 200. Transmitting network node 200 has a trigger receiving device 208 for receiving trigger signal ts, the trigger receiving device being able to act, for example, upon internal time reference 202 or also upon signal processing unit 204.

Trigger signal ts is advantageously used to induce transmitting network node 200 to acquire sensor signal y(t) and/or to transmit sensor values sd to network node 100a.

This means that by emitting trigger signal ts, receiving network node 100a may signal to transmitting network node 200, that sensor data values should be acquired or transmitted.

Trigger signal ts may be sent, and in particular, periodically, by receiving network node 100a to transmitting network node 200 as a function of primary time reference 102. In this case, secondary time reference 202 of transmitting network node 200 may also advantageously synchronize itself with primary time reference 102, since information establishing the temporal relationship between time references 102, 202 is formed periodically by trigger signal ts.

Alternatively or additionally, receiving network node 100a may also emit trigger signal ts as a function of an external trigger signal ts′, which the receiving network node 100a obtains from an external source such as a control unit of a motor vehicle or the like.

In the time characteristic of sensor signal y(t) of FIG. 2, a triggering time t0 corresponding to trigger ts is symbolized by a block arrow T at time t0.

In a further advantageous, specific embodiment of network node 200, it is provided that network node 200 be configured to calculate an average value over a plurality of sampling values of acquired sensor signal y(t), and to transmit the average value to receiving network node 100. This variant of the exemplary embodiments and/or exemplary methods of the present invention may be used in a particularly advantageous manner, when a sampling rate of sensor signal y(t) by transmitting network node 200 is relatively large in comparison with a transmission rate of data frames, as are transmitted by transmitting network node 200 to receiving network node 100a in order to route sensor data sd to receiving network node 100a.

In a further advantageous, specific embodiment of network node 200, it is provided that network node 200 be configured to perform data compression over a plurality of sampling values of acquired sensor signal y(t), and to transmit compressed sensor data to receiving network node 100, 100a.

In an advantageous manner, the further signal processing steps described above (averaging, data compression) may be executed, in turn, by a signal processing unit 204 of transmitting network node 200.

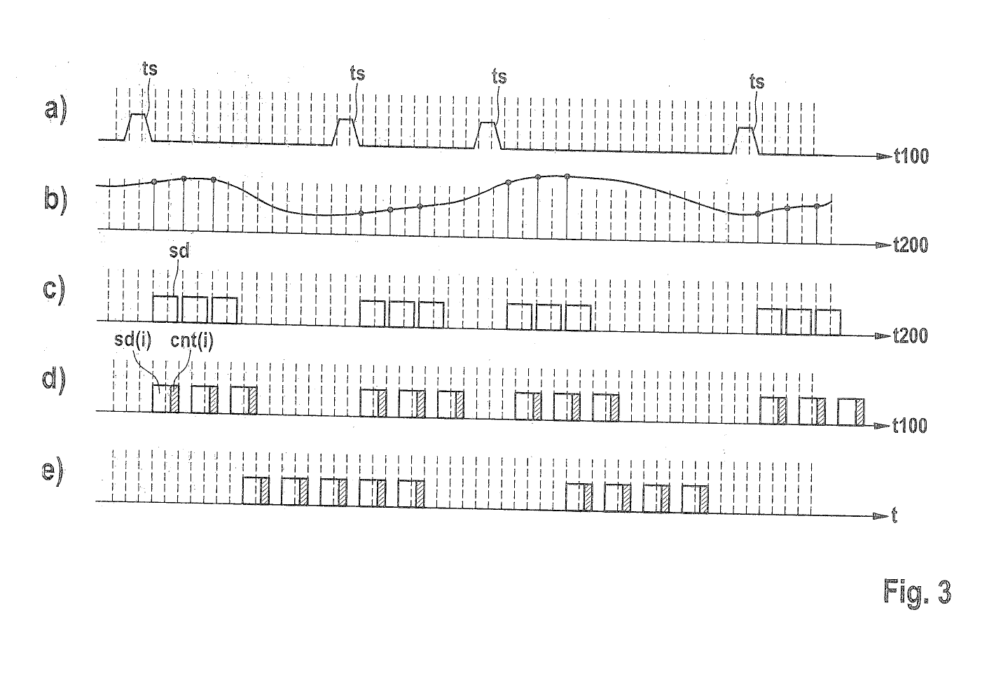

FIGS. 3a) to 3e) each show a time characteristic of different operating variables of the sensor network according to FIG. 2

FIG. 3a) shows a characteristic curve of trigger signal ts, as is output by receiving network node 100a to transmitting network node 200. The time characteristic of trigger signal ts is plotted over a time axis t100, which corresponds to primary time reference 102 of receiving network node 100a.

FIG. 3b) shows a time characteristic of sampling values, as are obtained by transmitting network node 200 by sampling sensor signal y(t) in reaction to the reception of trigger signal ts. The sampling values according to FIG. 3b) are plotted over a time axis t200, which corresponds to secondary time reference 202 of transmitting network node 200.

It is apparent from FIG. 3b) that in the exemplary embodiment described above by way of example, a total of three sampling values are obtained by transmitting network node 200 in reaction to the reception of each trigger signal ts. The transmission of corresponding sensor data sd takes place in a close temporal relationship with the determination of the corresponding sampling values from FIG. 3b; see also FIG. 3c) for comparison, which represents the time characteristic of sensor data sd, as are transmitted to receiving network node 100a.

FIG. 3d) shows combinations obtained according to the exemplary embodiments and/or exemplary methods of the present invention, the combinations being of, in each instance, a sensor data value sd(i), as is obtained at the output of digital communication interface 108 of receiving network node 100a, and a corresponding time stamp cnt(i), as is assigned to the corresponding sensor data value sd(i) by time stamp unit 106 of the exemplary embodiments and/or exemplary methods of the present invention.

Finally, FIG. 3e) shows the time characteristic of a further processing of the sensor data values sd(i) provided with time stamp cnt(i), as may be performed, for example, by evaluation unit 112 of receiving network node 100a.

From FIG. 3e), it is apparent that the combinations of sensor data values sd(i) and corresponding time stamp cnt(i), which are obtained according to the exemplary embodiments and/or exemplary methods of the present invention, are not necessarily processed in the same chronological sequence as they are received from transmitting network node 200 in the area of communication interface 108. Rather, on the basis of the present invention's assignment of the time stamps to the sensor data values, a subsequent evaluation in block 112 may take place completely detached from the arrival times of individual sensor data values sd(i) in receiving network node 100a.

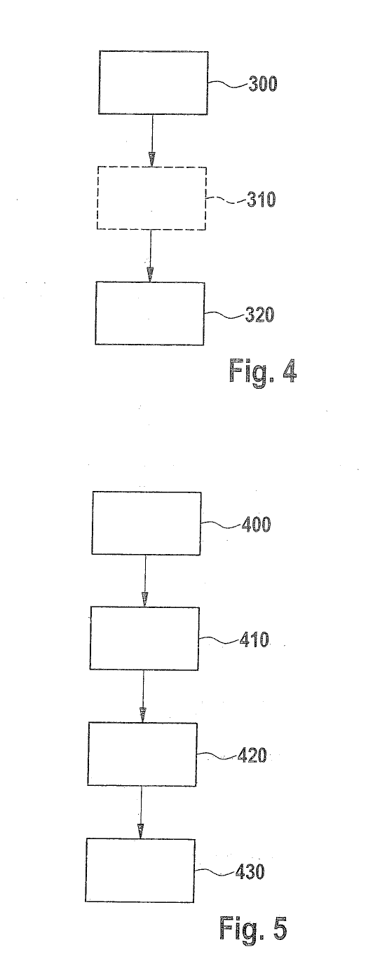

FIG. 4 shows a simplified flow chart of a specific embodiment of the present invention's operational method for transmitting network node 200, c.f. FIG. 1.

In a first step 300 (FIG. 4), transmitting network node 200 acquires sensor signal y(t). For example, in step 300, digital, discrete-time and discrete-value sampling values may be obtained as a function of sensor signal y(t).

In a subsequent, optional step 310, signal processing may already be performed in transmitting network node 200. For example, signal processing 310 may include averaging over several sampling values or data compression.

Subsequently, in step 320, sensor data sd are sent by transmitting network node 200 to receiving network node 100.

FIG. 5 shows a simplified flow chart of a specific embodiment of an operational method for receiving network nodes 100, 100a of the exemplary embodiments and/or exemplary methods of the present invention.

In a first step 400, digitally transmitted sensor data sd are received from at least one transmitting network node 200 with the aid of communication interface 108.

In a subsequent step 410, receiving network node 100 assigns received sensor data values sd(i) one time stamp cnt(i) each, using time stamp device 106; the time stamp representing a time of reception of sensor data values sd(i) at network node 100 with respect to a primary time reference 102 assigned to network node 100.

In subsequent step 420, network node 100 ascertains parameters of secondary time reference 202 of the network node 200 transmitting sensor data sd, which takes place, in particular, as a function of a frame length and/or a symbol transmission rate of digitally transmitted sensor data sd.

Finally, in step 430, a further evaluation of the received sensor data or of the sensor data values sd(i) provided with time stamp cnt(i) is performed.

According to the exemplary embodiments and/or exemplary methods of the present invention, one may advantageously dispense with a network node 200 transmitting sensor data sd having to perform time stamping itself, as well as having to transmit sensor data sd, together with the time stamps, to a receiving network node 100, 100a. In an advantageous manner, the network nodes 100, 100a of the exemplary embodiments and/or exemplary methods of the present invention that receive the sensor data may themselves undertake time stamping, which defines the entry time of the received sensor data with regard to primary time reference 102 of receiving network node 100, 100a, so that subsequent processing of the received sensor data may be carried out independently of any delay times in receiving network node 100, 100a.

What is claimed is:

1. A network node, which is for a sensor network, the network node being configured to receive sensor data from at least one further network node transmitting the sensor data, comprising:
a time stamp device, which is configured to assign received sensor data values to time stamps, which represent a time of reception of the sensor data values at the network node with respect to a primary time reference assigned to the network node.

2. The network node of claim 1, wherein the receiving network node is configured to ascertain parameters of a secondary time reference of the transmitting network node sending the sensor data, at least one of: (i) as a function of at least one of a frame length and a symbol transmission rate of the received sensor data, (ii) as a function of characteristic pulse shapes or pulse patterns, and (iii) as a function of characteristic patterns of the data stream that contains the sensor data.

3. The network node of claim 2, wherein the network node is configured to establish a relationship between the primary time reference and the secondary time reference as a function of the ascertained parameters of the secondary time reference.

4. The network node of claim 1, wherein the network node is configured to at least one of sectionally reconstruct and partially reconstruct a sensor signal originally acquired by the transmitting network node, from the received sensor data values, using at least one of the time stamps and a relationship between the primary time reference and the secondary time reference.

5. The network node of claim 1, wherein the network node is configured to transmit a trigger signal to at least one further network node, and wherein in the at least one further network node, the trigger signal triggers at least one of (i) an acquisition of a sensor signal, and (ii) the transmission of sensor data to the network node.

6. The network node of claim 1, wherein the network node is configured to transmit periodically a trigger signal to at least one further network node, so as to synchronize a secondary time reference of the further network node with the primary time reference.

7. A network node, which is for a sensor network, comprising:
an acquiring arrangement to acquire at least one sensor signal; and
a transmitting arrangement to transmit sensor data characterizing the acquired sensor signal to at least one network node receiving the sensor data;
wherein the network node is configured to transmit the sensor data to the receiving network node as a function of a secondary time reference, which is assigned to the network node and which is asynchronous with respect to a primary time reference of the receiving network node.

8. The network node of claim 7, wherein the network node is configured to receive a trigger signal and to at least one of (i) acquire the sensor signal, and (ii) transmit sensor data to the network node as a function of the trigger signal.

9. The network node of claim 7, wherein the network node is configured to receive a trigger signal and to synchronize its secondary time reference with a primary time reference of a network node sending the trigger signal, as a function of the trigger signal.

10. The network node of claim 7, wherein the network node is configured to calculate an average value over a plurality of sampling values of the acquired sensor signal, and to transmit the average value to the receiving network node.

11. The network node of claim 7, wherein the network node is configured to perform a data compression over a plurality of sampling values of the acquired sensor signal, and to transmit compressed sensor data to the receiving network node.

12. A method for operating a network node, which is for a sensor network, the network node being configured to receive sensor data from at least one further network node transmitting the sensor data, the method comprising:
assigning, using the network node, with the aid of a time stamp device, received sensor data values to time stamps, which represent a time of reception of the sensor data values at the network node with respect to a primary time reference assigned to the network node.

13. The method of claim 12, wherein the network node ascertains parameters of a secondary time reference of the transmitting network node sending the sensor data, at least one of (i) as a function of at least one of a frame length and a symbol transmission rate of the received sensor data, (ii) as a function of characteristic pulse shapes or pulse patterns, and (iii) as a function of characteristic patterns of the data stream that contains the sensor data.

14. The method of claim 12, wherein the network node at least one of (i) establishes a relationship between the primary time reference and the secondary time reference as a function of the ascertained parameters of the secondary time reference, and (ii) at least one of sectionally reconstructs and partially reconstructs a sensor signal originally acquired by the transmitting network node, from received sensor data values, using at least one of the time stamps, and the relationship between the primary time reference and the secondary time reference.

15. The method of claim 12, wherein the network node transmits a trigger signal to at least one further network node, so as to at least one of (i) trigger, in the at least one further network node, at least one of an acquisition of a sensor signal and the transmission of sensor data to the network node, and (ii) synchronize a secondary time reference of the further network node with the primary time reference.
